(19) United States
(12) Patent Application Publication
(10) Pub. No.: US 2003/0135428 A1
(43) Pub. Date: Jul. 17, 2003

(54) Internet-based method and system for managing order updates for delivery of goods

(76) Inventor: Timothy Jay Smith, Elizabethtown, KY (US)

Correspondence Address: BEUSSE, BROWNLEE, BOWDOIN & WOLTER, P. A., 390 NORTH ORANGE AVENUE, SUITE 2500, ORLANDO, FL, 32801, US

(21) Appl. No.: 10/042,912

(22) Filed: Jan. 11, 2002

(51) Int. Cl. G06F 17/60

(52) U.S. Cl. 705/27

(57) ABSTRACT

Method and system for managing delivery of goods from a supplier to a buyer are provided. The delivery generally involves at least one delivery agent, at least one store, at least one supplier, and a plurality of buyers, wherein the at least one delivery agent, the at least one store, and the at least one supplier are accessible through a communications network. The method allows to provide a Web page that includes a first data field for inputting an original purchase order identifier. The Web page further includes a second data field for inputting a new purchase order identifier. Respective retrieving actions allow to retrieve original order information associated with the original purchase order identifier, and updated order information associated with the new purchase order identifier. A relating action allows to relate the new purchase order identifier to an original delivery slot assigned to the original purchase order identifier so that the original delivery slot is kept notwithstanding of modifications made to the original order.

### BACKGROUND OF THE INVENTION

This invention generally relates to goods delivery management, and, more particularly, to Internet-based goods delivery management system and method which minimize the need for direct human interaction for processing order updates.

It is known that at least one other company has employed an Internet based goods delivery system wherein the goods can be ordered from one particular store and delivered to a designated buyer's address. For example, Home Depot Company has employed an Internet based appliance delivery system that enables a buyer to place an Internet based order for a branded good, and the respective good be delivered to the buyers designated address. Once the order is placed, the order is sent to a respective delivery agent via the Internet. The respective delivery agent then delivers the respective good. Unfortunately, such system has a number of disadvantages, including, for example: the system could not automatically generate order reschedules resulting from “refusals”, “cancellations”, “damaged” goods, “suspends”, and “shorts”.

Delivery management systems are known that provide Internet based delivery of standard sized packages, one particular example is the FEDERAL EXPRESS® goods delivery system. Non-standard sized packages are packages that are generally not delivered by air carriers and mail delivery services, and typically are packages that weigh over about 100 lbs. (45 kg). The delivery of non-standard packages generally requires a respective delivery agent who is equipped to ship the goods, install them, or both. For example, there may be a plurality of appliance delivery services that receive the appliance from the appliance manufacturer, deliver and/or install the appliance after the purchaser has ordered the appliance from a local appliance store. This entire operation is manually executed based on a delivery manifest. The delivery manifest is typically a document that identifies the delivery agent's good shipment schedule.

U.S. patent application Ser. No. 09/475,630, titled “Internet Based Goods Delivery System” and commonly assigned to the same assignee of the present invention, discloses innovative techniques and system for cost-effective and reliable delivery of non-standard size goods that minimize direct human contact between the buyer, the supplier, and the delivery agent. Although the foregoing system and techniques greatly simplify and expedite delivery of goods, it is further desirable to provide cost-efficient and reliable means that would allow the system to process updated order information and a new delivery order identifier associated with the updated order without losing or deleting any originally scheduled delivery of the goods. Deleting the original delivery could cause the buyer to lose their originally chosen delivery date and that buyer would be compelled to choose a new date. This generally undesirable event could occur under various scenarios. For example, loss of the original delivery date could occur, if during the deletion of the original order and the addition of the updated order, a second buyer was to be scheduled to take the delivery slot originally intended for the first buyer. Another example would be if, after the buyer has originally scheduled their delivery date, an overscheduling condition was to develop for the original delivery date. In this scenario, deleting the original order would prevent any updated order from being added back to the overscheduled date. Thus, to ensure and promote buyer good will, it would be desirable to provide an improved delivery management system which overcomes the foregoing issues.

### BRIEF SUMMARY OF THE INVENTION

Generally, the present invention fulfills the foregoing needs by providing, in one aspect thereof, a method for managing delivery of goods from a supplier to a buyer. The delivery generally involves at least one delivery agent, at least one store, at least one supplier, and a plurality of buyers, wherein the at least one delivery agent, the at least one store, and the at least one supplier are accessible through a communications network. The method allows to provide a Web page that includes a first data field for inputting an original purchase order identifier. The Web page further includes a second data field for inputting a new purchase order identifier. Respective retrieving actions allow to retrieve original order information associated with the original purchase order identifier, and updated order information associated with the new purchase order identifier. A relating action allows to relate the new purchase order identifier to an original delivery slot assigned to the original purchase order identifier so that the original delivery slot is kept notwithstanding of modifications made to the original order.

The present invention further fulfills the foregoing needs by providing in another aspect thereof a computer-readable medium encoded with computer program code for managing delivery of goods from a supplier to a buyer. The delivery generally involves at least one delivery agent, at least one store, at least one supplier, and a plurality of buyers, wherein the at least one delivery agent, the at least one store, and the at least one supplier are accessible through a communications network. The program code causes a computer to execute a method that allows to retrieve original order information associated with an original purchase order identifier. The method further allows to modify the original order information to generate updated order information. An associating action allows to associate a new purchase identifier with the updated order information. A relating action allows to relate the new purchase order identifier to an original delivery slot assigned to the original purchase order identifier so that the original delivery slot is kept notwithstanding of any modification to the original order information. Another relating action allows to relate buyer demographic data included in the original purchase order information to buyer demographic data in the new purchase order information. A validating action allows to validate that the original and updated orders correspond to the same buyer based on the buyer demographic data relating action.

### BRIEF DESCRIPTION OF THE DRAWINGS

FIG. 1 is a block diagram representation illustrating exemplary components and/or users of a goods delivery system;

FIG. 2 illustrates further details of an Internet based communications network such as may be used for interconnecting the components of the system of FIG. 1;

FIG. 3 illustrates an exemplary business process flow diagram such as may be performed by the goods delivery system of FIG. 1;

FIG. 4 illustrates a block diagram of the flow of information between the components of the goods delivery system; and

FIG. 5 illustrates an exemplary block diagram illustrating a system that in accordance with one aspect of the present invention allows to process updated order information without having to lose a delivery slot assigned to an original order of a buyer.

### DETAILED DESCRIPTION OF THE INVENTION

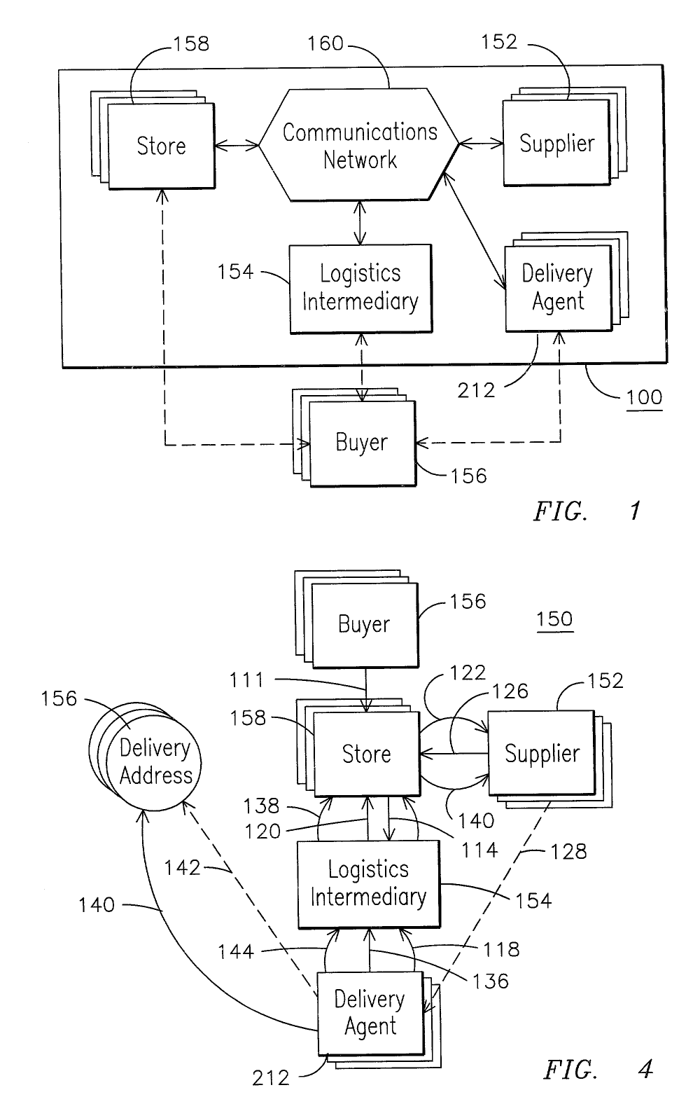

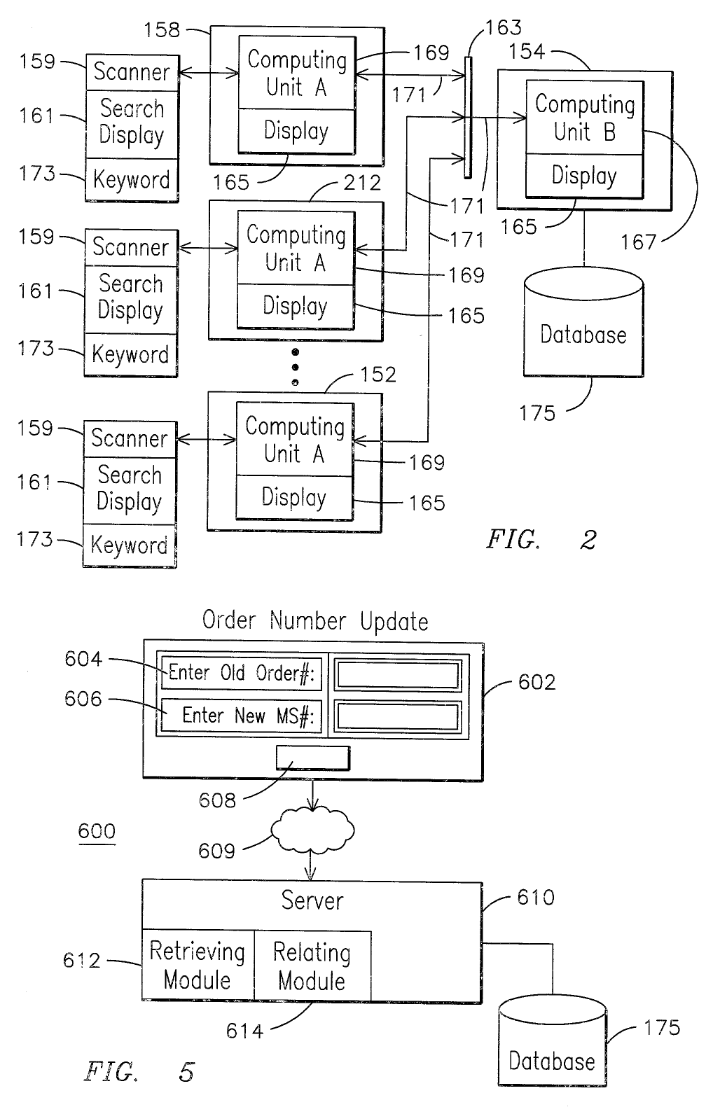

Now referring to FIGS. 1 and 2, which illustrate exemplary components that cooperatively interact to make up a goods delivery system 100, and wherein like reference numbers identify like elements. Goods delivery system 100 comprises components that cooperate in a process that integrates logistical supply chain parties by utilizing a global communications network, such as the Internet, commercially available peripheral devices, e.g., scanners, keyboard, voice recognition module, etc., and Internet based programs. The system enables a product distribution supplier to seamlessly interact with sellers of the supplier's products and suppliers to the sellers and buyers. Each supplier to the seller and alternatively, to the buyer, is referred to as a delivery agent 212. All parties of the above-identified logistical supply chain may execute roles and responsibilities while minimizing human interaction between the parties.

Internet based goods delivery system 100 may be usable by at least one supplier 152, at least one delivery agent 212, a logistics intermediary 154, and at least one store 158, through a communications network 160. Buyer 156 typically places an order at a respective store 158 requesting a desired good to be shipped, a desired delivery date, and a desired installation service. At each store 158, delivery agent 212, and supplier 152 there is at least one computing unit 169, which is coupled to a computing unit 167 via communications network 160. In one exemplary embodiment, communications network 160 comprises a Internet based communications link 171 and a server 163. Communications link 171 may use audio and alternatively fiber optic communications means to support server 163 based communications. In one exemplary embodiment, computing units 169 and 167 communicate using the Transmission Control Protocol/Internet Protocol (TCP/IP). Server 163 is typically an Internet based server which interfaces with a plurality of browsers so as to effect Internet based communications. Computing unit A 169 and computing unit B 167 comprises a respective browser. One exemplary browser is the Microsoft Internet Explorer™ browser. Computing unit A 169 may also comprise a commercially available display 165 and a commercially available scanner 159. Scanner 159 also has a scanner display 161, a keyboard 173, and is adapted to interface with computing unit A 169.

In one exemplary embodiment, the server may be accessed by computing units 169 and 167 by providing a web address having a suitable Uniform Resource Locator (URL) hyperlink, e.g., “www.geappliances.com” and by providing an associated password, as generally supported by commercially available web browsers. Computing unit 167, e.g., located at logistics intermediary 154, may be loaded with software which enables to run the delivery management system and the electronic manifest. Unit 167 may further be coupled to a database 175 configured to store order information, such as may be received from store 158 to fulfill an order placed by a buyer. It is noted that the delivery management system, including database 175 and the electronic manifest may be located at any desired site, including, for example, store 158, delivery agent 212, and supplier 152. The electronic manifest provides a delivery management control algorithm that effectuates control and enables information storage for goods delivery system 100. As suggested above, the delivery management system includes a computer program embedded in any suitable storage medium readable by computer units 169 and 167, and configured to run a set of instructions for executing a computer process for managing the ordering and shipping of goods of a goods delivery system.

The delivery management system facilitates the scheduling of deliveries from supplier 152 to buyer 156 by delivery agent 212, based on the delivery date selection at the point-of-sale. The point-of-sale may, by way of example and not limitation, be respective store 158, respective supplier 152, respective delivery agent 212, or respective buyers delivery address. Copending U.S. patent application 9D-EC-19335, (Ser. No. 09/475,961) provides details of the delivery management system. Copending U.S. patent application 9D-EC-19319, (Ser. No. 09/475,962) provides details of the capacity tracking and prediction portion of the delivery management system.

An exemplary embodiment of the goods delivery system 100 is further illustrated and described below. By way of example and not limitation, the actions of a respective buyer 156 for ordering a branded appliance and having the appliance shipped and installed from respective supplier 152 to the address of that buyers, are described below. It is understood that the appliance may be any movable good and, generally, is a non standard sized good requiring special installation after delivery to respective buyer 156.

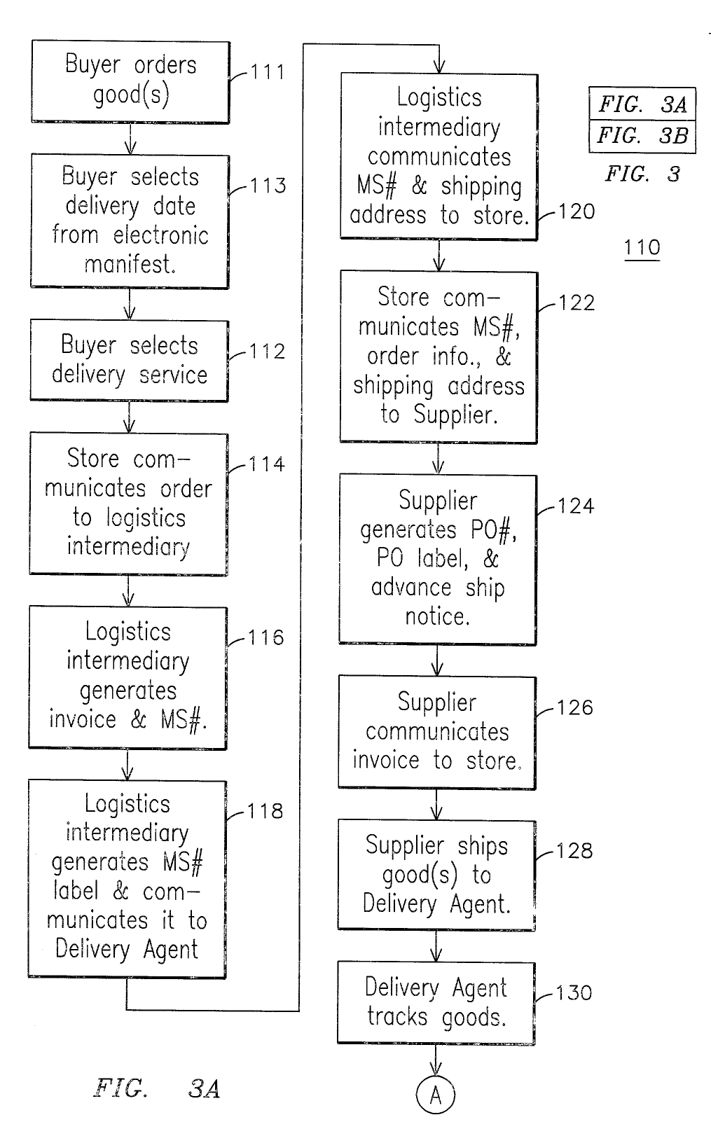

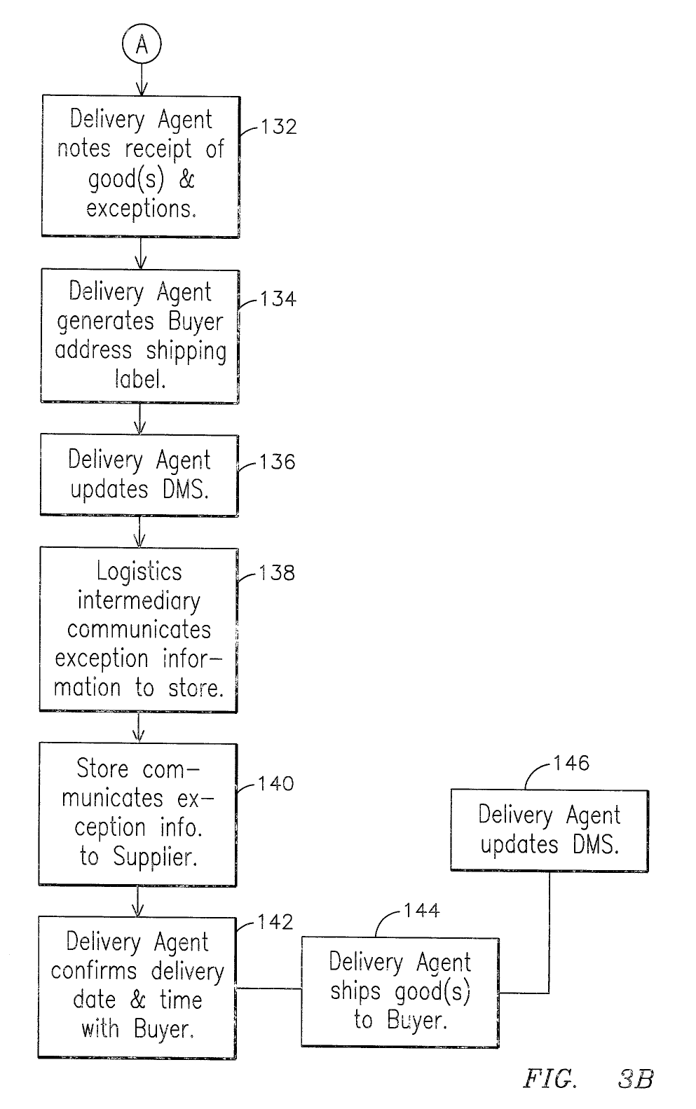

Referring now to FIGS. 3 and 4, wherein like elements have like reference numbers. FIG. 3 illustrates exemplary process steps 110 associated with goods delivery system 100, and FIG. 4 illustrates the exchange of information between components of the goods delivery system 100. As suggested above, exemplary components and/or users of goods delivery system 100 comprise respective store 158, communications network 160, respective supplier 152, logistics intermediary 154, and delivery agent 212. At step 111, respective buyer 156 orders the branded appliance at respective store 158. At step 113, buyer selects a delivery date, and at step 112 that buyer selects a delivery service from a computer display 165 configured to display the electronic manifest. The electronic manifest shows any of the available shipping dates within the specified delivery zone based on output from the delivery management system. Once the delivery slot is selected within the specified delivery zone the electronic manifest is immediately updated, showing the adjusted delivery date availability in each respective delivery zone.

Store 158 communicates the order information to logistics intermediary 154, as illustrated in step 114. Order information comprises the model number, the quantity of goods, the brand of the good, the desired installation service, the desired delivery date, and the delivery address. Examples of the desired installation service include, removal of old appliance, connecting new appliance to water, gas, and electric service, and adding the capability to connect to water, gas, and electric service. It is understood that the desired installation service may also include any service associated with the delivery of the good to the buyer address that the delivery agent 212 is contracted to perform.

Logistics intermediary 154 generates a master requisition and a manufacturer shipping number for each respective appliance order that is associated with the master requisition, as shown in step 118. Logistics intermediary 154 also generates an invoice associated with the master requisition showing the bill to be paid by store 158, also shown in step 116.

Logistics intermediary 154 next generates a bar coded master requisition number and manufacturing shipping number for each good to be shipped to a respective delivery agent, as illustrated in step 116. These bar codes are typically communicated to the delivery agent 212, step 118. In this specification the term “communicate” is defined to identify any form of communications, including but not limited to, being mailed, being delivered by courier, being faxed, and being communicated via the Internet. Logistics intermediary 154 next communicates, via the Internet, the manufacture shipping number and buyer shipping address for each order to store 158 which originally placed the order, as shown in step 120.

Respective store 158 next communicates, via the Internet, the manufacture shipping number and buyer mailing address to respective supplier 152, as illustrated in step 122. Respective supplier 152 can thus determine which delivery agent to ship the order to based on the buyer's shipping address. Respective supplier 152 next generates a respective purchase order, a purchase order label, and advance shipping notice, as shown in step 124. Respective supplier 152 then supplies the respective goods invoice to respective store 158 only for supplier branded goods, as shown in step 126. Respective supplier 152 next attaches the purchase order label to the goods. Respective supplier 152 next communicates the advance shipping notice to respective delivery agent 212 and ships the goods to respective delivery agent 212, as illustrated in step 128.

Delivery agent 212 has the capability of cross checking the shipping status and tracking the goods (step 130) utilizing any combination of the following: 1) by monitoring the activity on the electronic manifest, 2) by reviewing the bar codes mailed from logistics intermediary 154, and 3) by receipt of the advance shipping notice from by supplier 152.

Upon receipt of goods delivery agent 212 notes receipt of goods and notes exceptions, as illustrated in step 132. When the goods are received by the delivery agent 212 the master schedule bar code on the outer carton is scanned. This scanning action is intended to provide shipping confirmation for the electronic manifest, which notes that the goods have arrived from supplier 152. Bar codes received from logistics intermediary 154 are attached to each good having a manufacturer shipping number. Finally, exceptions are recorded. In one exemplary embodiment, an exception report may include an “overage”, a good “shortage”, a “damaged” good, or a “suspend” action as further described below.

The “overage” exception allows to identify goods that were shipped which were not expected based on the electronic manifest or alternatively based on the advanced shipping notice. The model number of the “overage” good is recorded into scanner 159 for identification, upon prompting by display 161 showing an exceptions menu from which an “overage” menu may be selected.

The “shortage” exception allows to identify goods that were expected to be shipped based on both the electronic manifest and based on the advanced shipping notice, but did not arrive. At this point the manufacturer shipping number from logistics intermediary 154 is keyed into scanner 159 by the user upon prompting by display 161 showing the exceptions menu from which a “shortage” menu may be selected.

The “damage” exception allows to identify goods that were shipped but include visible damage to the shipping carton, to the goods, or both, e.g., scratches, dents, missing parts—the damage having a cumulative predetermined value, typically, greater than or equal to $20. The disposition of the goods is keyed into the scanner upon prompting by display 161 in the exception menu, from which a “damage” menu 260 may be selected. The damage good exception report triggers an issuance of a replacement order and a return authorization of the original good.

The “suspend” exception allows to identify goods wherein the manufacturer shipping number labels and shipping requisition arrived but the order was not shipped. Generally, the order will be shipped on a subsequent shipment to delivery agent 212, as such, an exception process similar to the “shortage” process described above is followed. A “suspend” menu would be used, instead of the “shortage” menu.

FIG. 5 illustrates an exemplary block diagram representation of a system 600 in accordance with one aspect of the present invention. System 600 allows the various parties involved in the delivery of goods, such as delivery agent, store, and supplier, to more effectively serve the needs of such buyers of goods, particularly, when a respective buyer has a need to update an order originally placed by that buyer. It will be understood that the order need not be placed directly by the buyer since a customer service representative of the supplier, or similar representative of the store may have placed the order on behalf of the buyer. The system is configured to perform a method that enables keeping or preserving a delivery slot that may have been assigned to the original order, notwithstanding of modifications that may be made to the original order to reflect new needs or desires of the buyer.

As shown in FIG. 5, a Web page 602 is provided by server 610 through a communications network 609, such as the Internet. The Web page includes a first data field 604 for inputting an original purchase order identifier, e.g., an original purchase order number. Web page 602 further includes a second data field 606 for inputting a new purchase order identifier, e.g., a new purchase order number. Upon submittal by clicking, for example, on a submit icon 608, a retrieving module 612 is configured to retrieve original order information associated with the original order identifier. The original order information may be stored in a suitable database 175 coupled to server 610. By way of example, the original order information may comprise, model number, quantity of goods, brand of the good, desired installation services, and demographic data of the buyer, such as name of the buyer, residence address, telephone number, E-mail address, etc. Retrieval module 612 is further configured to retrieve updated information associated with the new purchase order identifier. For example, the updated information may be indicative of a different color desired by the buyer for the appliance, or indicative of additional services required as part of the installation, such as removal of an old appliance, etc. A relating module 614 is configured to relate the new purchase order identifier to the original delivery slot assigned to the original purchase order identifier so that the original delivery slot is kept. Relating module 614 may be further configured to relate buyer demographic data included in the original purchase order information to buyer demographic data included in the updated purchase order information. This relating action of buyer demographic data allows for validating that the original and updated orders actually correspond to the same buyer. For example, this relating action may involve comparing one or more parameters of the demographic data, or combinations of such parameters, to validate that in fact the original and updated orders correspond to the same buyer. For example, if the buyer demographic data in the original order information lists buyer John Doe residing in a FirstTown with phone number 123-4567. And the buyer demographic data in the updated order information lists buyer John Doe in the same FirstTown with the same phone number, then it is highly probable that such orders would correspond to the same buyer. Conversely, if the buyer demographic data in the updated information lists buyer John Doe, residing in SecondTown, then further verification would be required to resolve the resulting ambiguity as to whether such orders correspond to the same buyer.

Referring again to FIGS. 3 and 4, delivery agent 212, after completing the disposition of the goods, communicates the disposition of the goods to logistics intermediary 154 via communications network 160, as illustrated by step 136 (FIG. 4). Logistics intermediary 154 then communicates the disposition of the goods to store 158 and Supplier 152, via communications network 160, as shown is steps 138 and 140.

Logistics intermediary 154 next generates buyer address shipping labels and communicates the labels to respective delivery agent 212. Respective delivery agent 212 access each respective shipping label to a respective shipping carton, as illustrated by step 134. Respective delivery agent 212 next confirms the delivery date and time with respective buyer 156 and ships the goods to respective buyer 156, as shown in steps 142 and 144. Finally, respective delivery agent 212 communicates the goods delivery disposition to logistics intermediary 154, as illustrated in step 146.

The present invention comprises an Internet based goods delivery system 100 having components that cooperate in a process that integrates logistical supply chain parties by utilizing the Internet, commercially available scanners, and Internet based programs. The system creates the capability for a product distribution supplier to seamlessly interact with sellers of the supplier's products and suppliers to the sellers and buyers. All parties of the logistical supply chain execute roles and responsibilities while minimizing human interaction between the parties. The goods delivery system enables a plurality of stores 158, suppliers 152, at least one delivery agent 212, and a logistics intermediary 154, to interact via communications network 160, as illustrated in FIG. 1. Goods delivery system 100 uses process flow 150, identified in FIG. 4 to move goods having different brands from respective supplier 152 to respective buyer 156, using at least one delivery agent 212. Since the process is integrated and communication is contemporaneously maintained between all parties human interaction is minimized.

The present invention can be embodied in the form of computer-implemented processes and apparatus for practicing those processes. The present invention can also be embodied in the form of computer program code including computer-readable instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. When implemented on a computer, the computer program code segments configure the computer to create specific logic circuits or processing modules.

It will be apparent to those skilled in the art that while the invention has been illustrated and described herein in accordance with the patent statutes, modifications and changes may be made in the disclosed embodiments without departing from the true spirit and scope of the invention. It is, therefore, to be understood that the appended claims are intended to cover all such modifications and changes as fall within the true spirit of the invention.

What is claimed is:

1. A method for managing delivery of goods from a supplier to a buyer, said delivery generally involving at least one delivery agent, at least one store, at least one supplier, and a plurality of buyers, wherein the at least one delivery agent, the at least one store, and the at least one supplier are accessible through a communications network, said method comprising:
providing a Web page including a first data field for inputting an original purchase order identifier, said Web page further including a second data field for inputting a new purchase order identifier;
retrieving original order information associated with said original purchase order identifier;
retrieving updated order information associated with said new purchase order identifier; and
relating said new purchase order identifier to an original delivery slot assigned to the original purchase order identifier so that said original delivery slot is kept notwithstanding of modifications made to the original order.

2. The method of claim 1 wherein said original order information comprises demographic data of the buyer, model number, quantity of goods, brand of the good, and desired installation services.

3. The method of claim 1 wherein said relating step enables the delivery agent to maintain an originally scheduled delivery of the goods.

4. The method of claim 1 further comprising relating buyer demographic data included in the original purchase order information to buyer demographic data in the new purchase order information; and
validating that said original and updated orders correspond to the same buyer based on said buyer demographic data relating action.

5. A computer-readable medium encoded with computer program code for managing delivery of goods from a supplier to a buyer, said delivery generally involving at least one delivery agent, at least one store, at least one supplier, and a plurality of buyers, wherein the at least one delivery agent, the at least one store, and the at least one supplier are accessible through a communications network, the program code causing a computer to execute a method comprising:
retrieving original order information associated with an original purchase order identifier;
modifying said original order information to generate updated order information;
associating a new purchase identifier with said updated order information;
relating said new purchase order identifier to an original delivery slot assigned to the original purchase order identifier so that said original delivery slot is kept notwithstanding said modifying action;
relating buyer demographic data included in the original purchase order information to buyer demographic data in the new purchase order information; and
validating that said original and updated orders correspond to the same buyer based on said buyer demographic data relating action.

6. The computer-readable medium of claim 5 wherein said original order information comprises model number, quantity of goods, brand of the good, and desired installation service.

7. The computer-readable medium of claim 1 further comprising providing a Web page including a first data field for inputting said original purchase order identifier, said Web page further including a second data field for inputting said new purchase order identifier and wherein said action of relating the new order identifier to the original delivery slot is performed upon submittal of said Web page including both of said purchase identifiers through said communications network.

8. A system for managing delivery of goods from a supplier to a buyer, said delivery generally involving at least one delivery agent, at least one store, at least one supplier, and a plurality of buyers, wherein the at least one delivery agent, the at least one store, and the at least one supplier are accessible through a communications network, the system comprising:
server configured to provide a Web page including a first data field for inputting an original purchase order identifier, and a second data field for inputting a new purchase order identifier;
retrieving module configured to retrieve original order information associated with said original purchase order identifier, said retrieving module further configured to retrieve updated order information associated with said new purchase order identifier; and
relating module configured to relate said new purchase order identifier to an original delivery slot assigned to the original purchase order identifier so that said original delivery slot is kept, said relating module configured to relate buyer demographic data included in the original purchase order information to buyer demographic data in the updated purchase order information to validate that said original and updated orders correspond to the same buyer.
